(19) United States
(12) Patent Application Publication
(10) Pub. No.: US 2011/0285122 A1
(43) Pub. Date: Nov. 24, 2011

(54) Method and apparatus for manufacturing a label

(75) Inventors: Stephen C. Hill, Perrysburg, OH (US); Edward L. Sharek, Perrysburg, OH (US)

(73) Assignee: CMC Group, Inc.

(21) Appl. No.: 13/066,492

(22) Filed: Apr. 15, 2011

Related U.S. Application Data
(60) Provisional application No. 61/396,158, filed on May 21, 2010.

(51) Int. Cl. B42D 5/04; B32B 38/14; B42D 15/00

(52) U.S. Cl. 283/2; 283/81; 156/277

(57) ABSTRACT

A label has a coating capable of receiving printing or other indicia directly from a thermal printer. The label as manufactured has printed thereon indicia representing each of the seven days of the week. As applied to a container of perishable goods, the labels has obliterations over each day of the week except the day by which the contents of the container should be used or, if not used, disposed of.

### CROSS REFERENCE TO RELATED APPLICATION

This application is based upon and claims the benefit of U.S. Provisional Patent Application No. 61/396,158 filed May 21, 2010.

### BACKGROUND OF THE INVENTION

The present patent application is directed to a label and method and apparatus for forming. It is known in the food packaging industry and other industries having perishable goods to provide a label for the package indicating a day of the week by which the food or other goods contained therein should be used. For example, CMC DayMark Corporation, Bowling Green, Ohio, manufactures labels with one day or a plurality of days of the week indicia.

### SUMMARY OF THE INVENTION

According to the present invention, a label is manufactured with a coating having the capability of being printed with a direct thermal printer as disclosed in U.S. patent application Ser. No. 12/384,429, filed Apr. 3, 2009 (incorporated herein by reference). Labels having the type of coating set forth in such patent application are printed to show each of the seven days of the week. Preferably, the labels have a different color in the area of each day. The packager affixing such labels to a container of perishable goods blocks out the indicia for each day of the week except one, thereby showing the day of the week by which the goods should be used. Under a preferred embodiment, the paper, the coating on which the seven days of the week are printed and an adhesive on the opposite side of the paper from the coating are dissolvable or dispersible in water. The coating formulation which permits the labels to be printed with a direct thermal printer is also dissolvable or dispersible in water.

### DESCRIPTION OF THE DRAWINGS

FIGS. 1-3 show a number of prior art day-of-week labels.

FIG. 4 is a plan view of a label of the present invention.

FIG. 5 is a portion of a length of a strip liner having a plurality of labels affixed thereto.

FIG. 6 is a sectional view of the label and liner strip.

FIG. 7 is a schematic view showing manufacture of the silicone liner strip.

FIG. 8 is a schematic view showing application of an adhesive to the coated liner strip and laminating the face paper to the coated liner strip.

FIG. 9 is a schematic view showing application of direct thermal coating to the surface of the face paper.

FIG. 10 is a schematic view showing cutting individual labels retained on the liner strip.

FIG. 11 is schematic view, in perspective, showing the dispensing of a liner strip and label from a direct thermal printer with all but one of the days of the week obliterated by printing from the direct thermal printer.

### DETAILED DESCRIPTION OF THE INVENTION

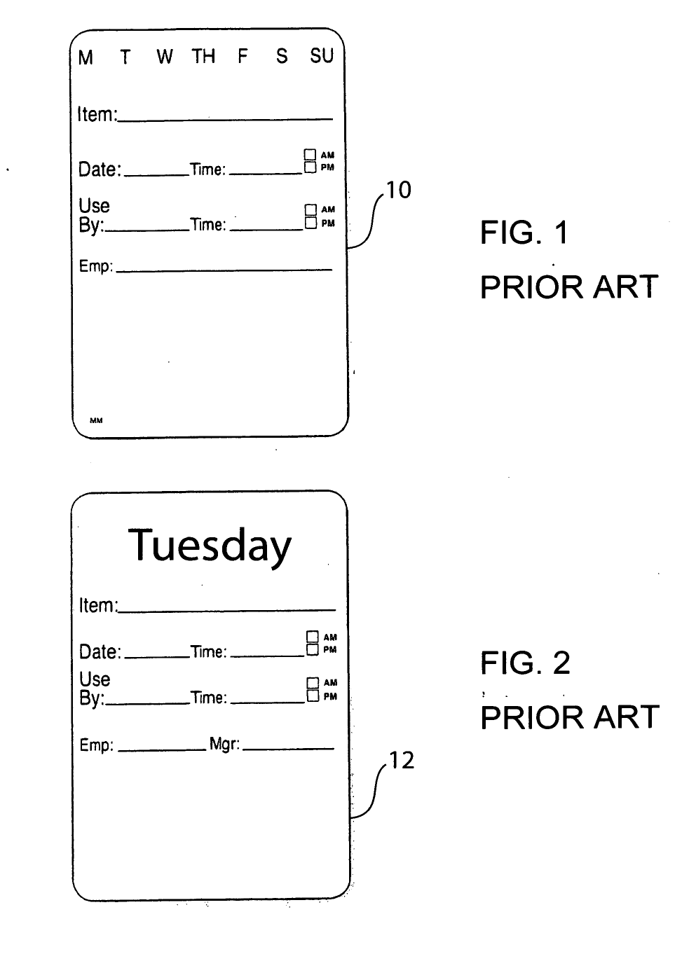

Prior examples are shown in FIGS. 1-3 which show labels currently manufactured and sold by CMC DayMark.

FIG. 1 shows a label 10 with the first or first two letters of each day of the week. When a package is assembled containing perishable goods, it is labeled with the label 10. The labeling personnel then circle one of the days of the week to indicate the day by which the product contained in the package should be used.

FIG. 2 shows another label 12 commercially available from CMC DayMark. It has a single day of the week printed thereon, for example “Tuesday”. This type of label would be sold along with other similar labels having other days of the week printed thereon.

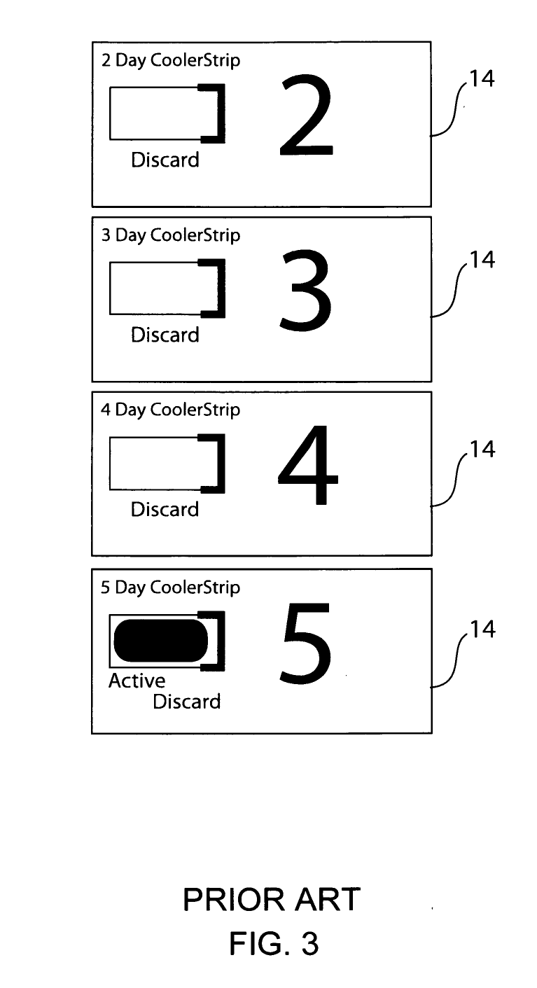

FIG. 3 shows other labels 14 which identify by number a specified number of days for maintaining goods in coolers.

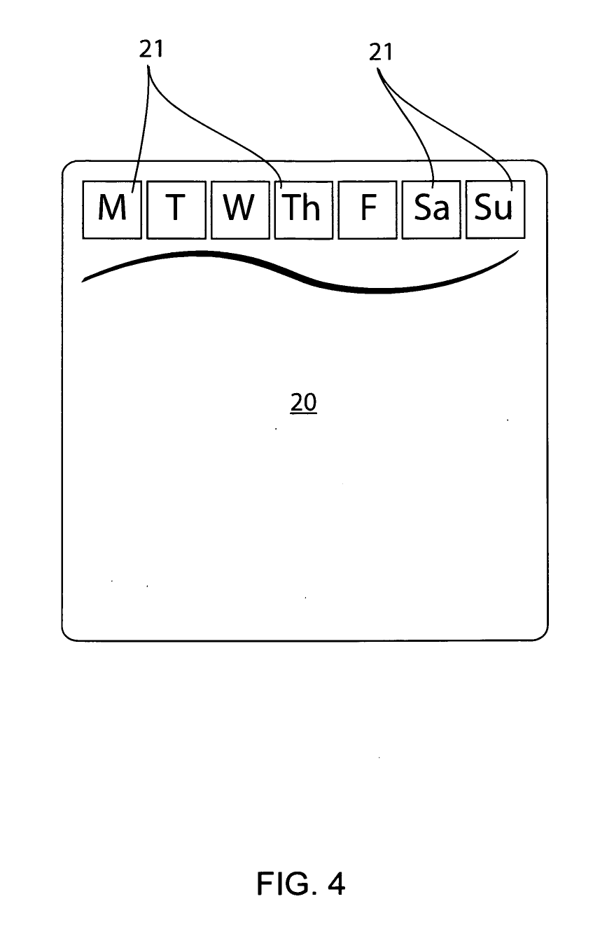

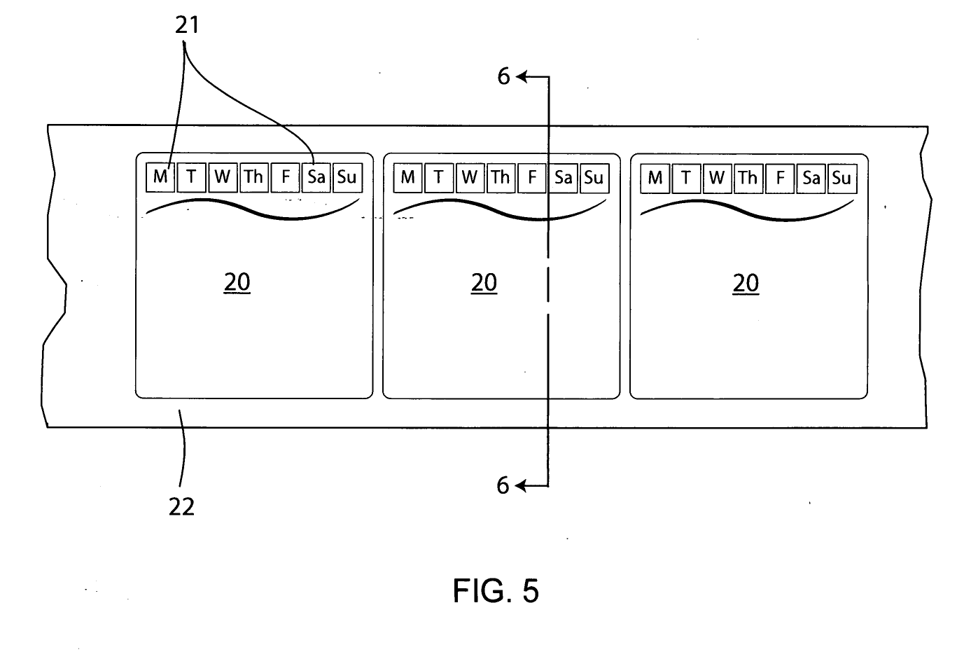

Referring to FIGS. 4-6, there is shown a label 20 (FIG. 4) and a plurality of labels 20 affixed to a liner strip 22 (FIG. 5). Each of the labels 20 is printed with indicia showing either the first letter or the first two letters of each of day of the week. Preferably each box 21 surrounding a day-of-week label is a different color. According to the present invention, each day of the week except one would be obliterated with printing prior to or immediately upon affixing the label to a container of goods so that the only day indicia showing would be indicia of the specific day of the week by when the goods should be used. Under a preferred embodiment of the present invention, the label includes a coating 24 of the type which may receive printing from a direct thermal printer.

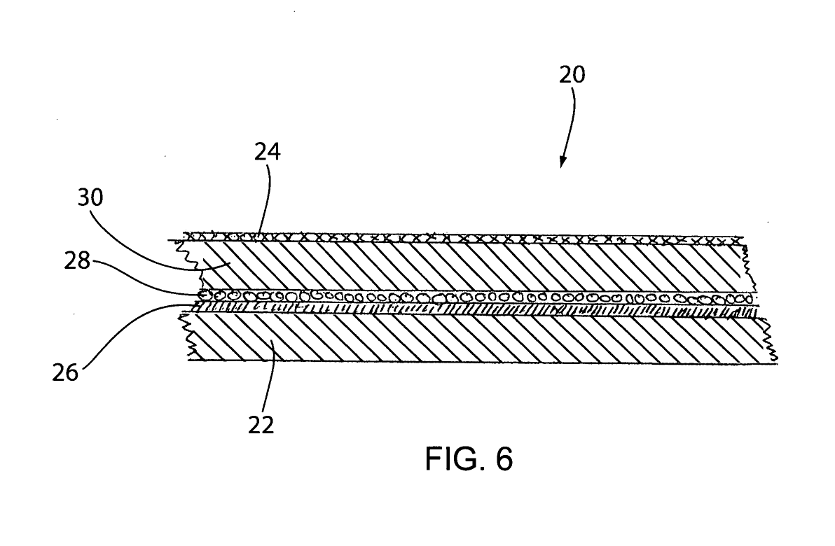

FIG. 6 is a sectional view showing the construction of the label 20 in combination with its liner strip 22. As shown in FIG. 6, the liner 22 has applied thereto a three-part silicone coating 26 of a type which is available from Dow Chemical Company, Midland, Mich. A layer of pressure sensitive adhesive 28 is applied to the silicone coating 26. The adhesive 28 is preferably water dissolvable or water dispersible in order to permit the label, following use, to be easily removed from the surface of the container to which it was affixed. A suitable water soluble adhesive may be obtained from one of a number of well known adhesive suppliers.

A layer of face paper 30 is affixed to the adhesive. Preferably the face paper 30 is water dissolvable or water dispersible. Water dissolvable or water dispersible paper is readily available on the market. See for example U.S. Pat. No. 6,828,018.

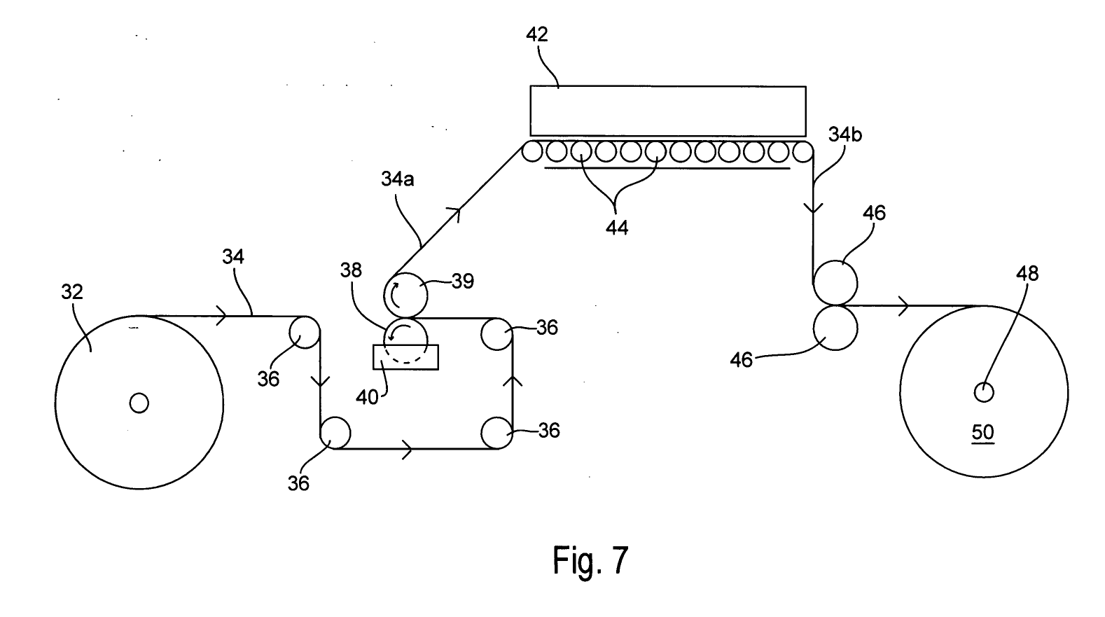

Referring now to FIGS. 7-10 there is shown the various steps in manufacturing the label and the combination label and liner of the present invention.

FIG. 7 shows a roll 32 of uncoated liner paper 34. Liner paper 34 is well known in the art and needs no further description except to say that a 40 pound liner paper is satisfactory for the purposes intended for the label/liner combination of the present invention. One surface of the liner paper 34 is coated with a coating of silicone, preferably, a 3-part silicone at 1.6 grams per square meter. The coating is applied by passing the length dispensed from the roll 32 over the rollers 36 and then between a pair of gravure revere rollers 38 and 39, one of which, gravure roller 38 as shown in FIG. 7, is rotated through a bath 40 containing liquid silicone which is transferred to the lower side (as viewed in FIG. 7) of the liner paper 34 as the liner paper passes through the nip between the gravure rollers 38 and 39.

As is well known in the field of gravure coating/printing, a doctor blade may be provided to wipe off excess silicone from the roller 38 shortly after such roller portion leaves the bath 40 and prior to its reaching the liner paper 34 at the nip between the first roller 38 and second roller 39 so that a precisely controlled amount of silicone will be applied.

The liner paper 34 with the uncured silicone coating (coated liner paper 34a) is then passed through a two zone oven 42 on a plurality of oven transfer rollers 44. The oven is maintained at a temperature of 315° F., which temperature is suitable for curing the silicone coating to the liner paper. The silicone cured liner paper 43b is passed between the nip of a pair of tension rollers 46 and then to a wind up station 48 to form a completed silicone liner strip roll 50.

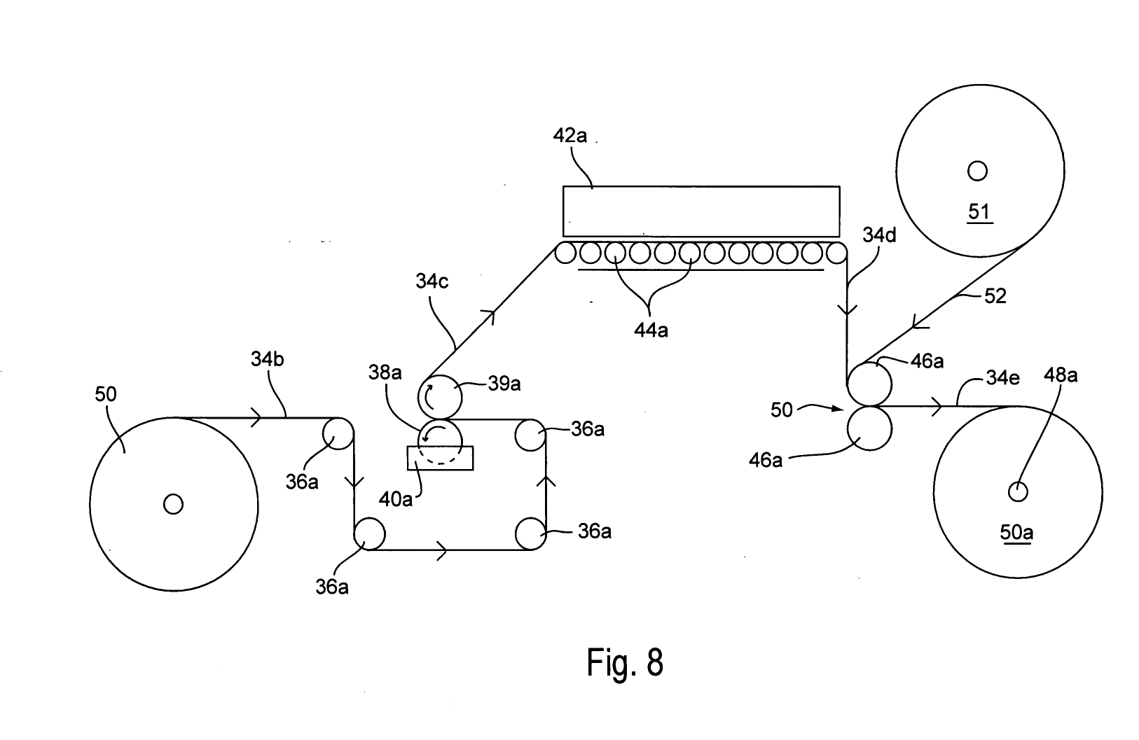

Referring now to FIG. 8, there is shown the steps of applying the adhesive coating over the silicone coating 26. As shown in FIG. 8 the completed liner roll 50 dispenses the silicone coated paper 34b, feeds it over four rollers 36a and between the nip of a pair of gravure rollers 38a and 39a. The lower roller as viewed in FIG. 8 is partially submerged in a bath 40a of liquid adhesive which is, preferably, dissolvable in water. The dissolving adhesive is applied with a coat weight of 21 grams per square meter. The liner paper with uncured adhesive leaving the nip between the gravure rollers 38a, 39a is identified by the numeral 34c.

The liner with uncured adhesive 34c is fed through an oven 42a over a series of transfer rollers 44a. The oven 42a is a two zone oven with differential temperatures ranging from 250° at the entrance end to 230° F. at the exit end to cure the silicone. The adhesive/silicone lined paper 34d is then fed between the nip of a pair of rollers 46a which cooperate to define a lamination station 50.

Dissolving paper 52 is fed from a supply roll 51 between the nip of a pair of rollers 46a at the lamination station and engages the adhesive of the adhesive/silicone liner 34d and is adhered thereto at the lamination station to form laminated paper 34e which is then fed to a wind up station 48a to form a completed roll 50a of the laminated liner/face paper 34e.

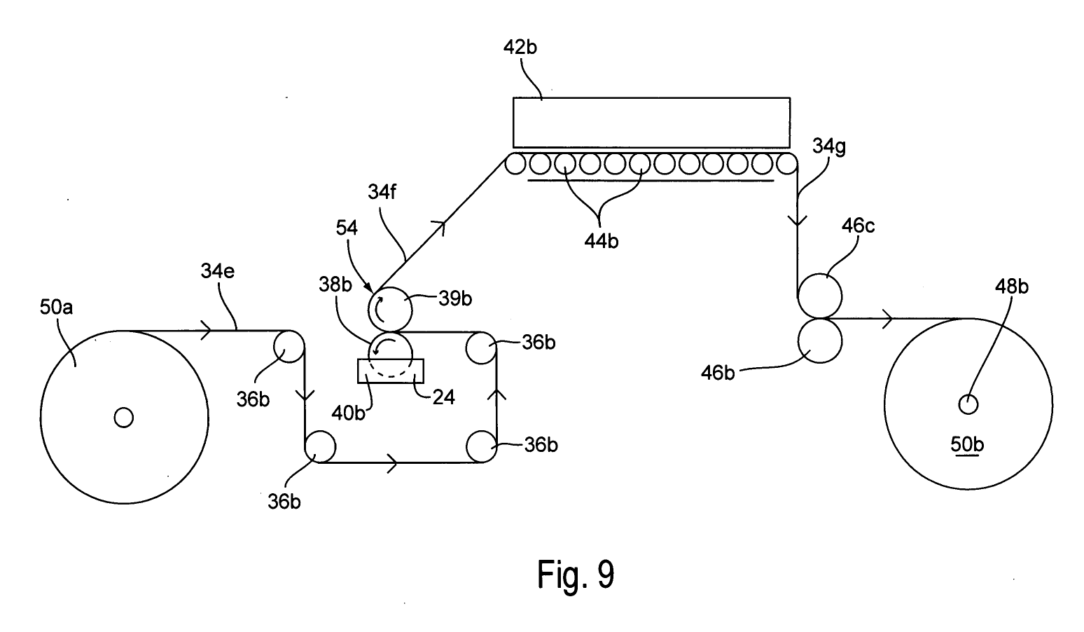

Referring now to FIG. 9, the roll 50a dispenses the laminated liner/face paper 34e, passes it over four rollers 36b and delivers it through the nip of gravure rollers 38b and 39b at a direct thermal coating station 54. The lower gravure roller 38b is partially submerged in a bath 40b containing liquid direct thermal coating material 24. Thermal coating material is readily available on the market and includes a number of suppliers including Consolidated Converting, Loretto, Ontario, Canada as its item No. 8957-M. The laminated liner/face paper exiting the coating station with the liquid direct thermal coating is identified by the numeral 34f. The direct thermal coating is applied at 5 grams per square meter to the side of the paper layer opposite the adhesive 28. The bath 40b contains the direct thermal coating 24 in liquid form.

A doctor blade maybe provided to wipe off excess coating material 24 from the first roller 38b shortly after such first roller leaves the bath and prior to its reaching the liner/face paper 34e at the nip between the first gravure roller 38b and second gravure roller 39b so that a precisely controlled amount of coating material will be applied. The coating 24 is thereby applied to the length liner/face paper 34e as it passes through the nip between the rollers 38b and 39b thereby forming a laminate (liner/face paper) with coating 34f.

Shortly thereafter, the direct thermal coated laminate 34f with the newly applied coating 24 passes through a drying oven 42b while being supported on rollers 44b. It is important that the newly coated lamination 34f be introduced to the oven 42b before the liquid of the water based coating material 24 has an opportunity to deteriorate the surface of the paper 30 to an extent which would adversely affect its quality. This is accomplished by promptly introducing the newly coated lamination 34f to the oven 42b. For example, the strip of coated lamination 34f is preferably moving over the rollers 44b at approximately 175 feet per minute. The distance from the entrance to the oven 42b from the coating station 54 to the first roller 44b is approximately 8 feet, with the result that, the length of time it takes for the lamination 34f with a newly applied coating to move from the second roller 15 to the entrance of the oven 42b is less than 3 seconds, which is too short a time period for the water based material 24 to adversely affect the paper 30.

The oven 42b is maintained at a temperature of 165° F. plus or minus 5° F. which is a temperature lower than that which would activate the coating 24. Any such activating of said coating could cause it to darken and detract from its ability to effectively receive clear images, printing or other indicia from a direct thermal printer. Additionally, the oven 42b is provided with high circulation in order to cause the coating 24 to dry rapidly. The length of the oven 42b is approximately 35 feet which is sufficient to result in a completely dried length of coated paper. The combination exiting the oven 42b, identified by the numeral 34g, is then fed between rollers 46b and 46c and passed to a wind up station 48b where it is wound into a roll 50b.

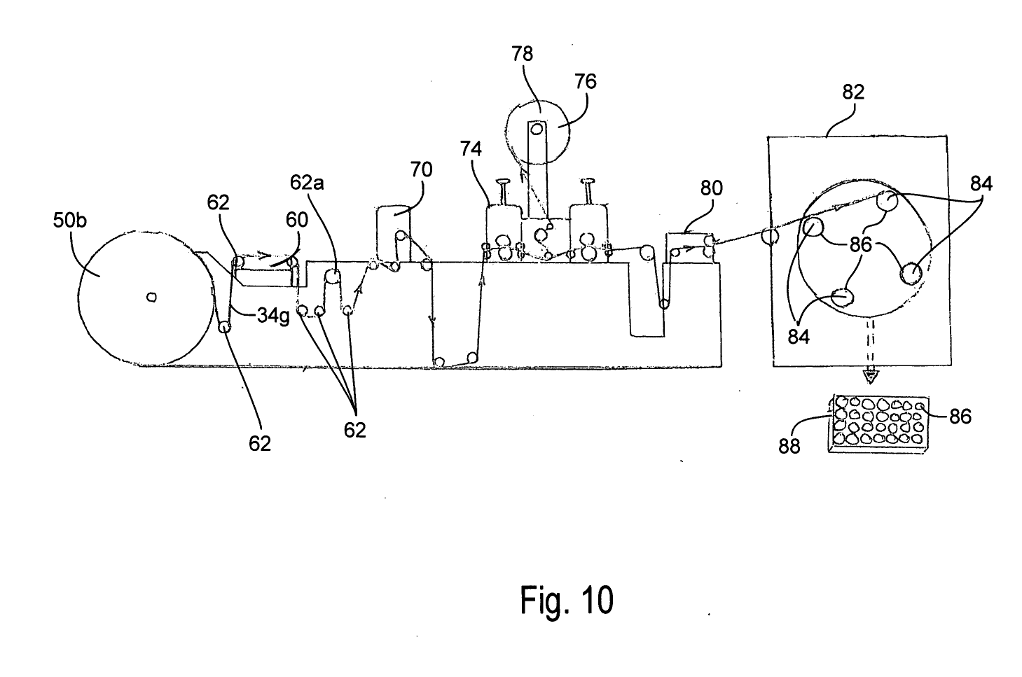

Referring now to FIG. 10 there is shown the steps involved in printing and die cutting the combination 34g to form labels 20 on a length of liner strip 22 and winding such liner strip 22 with labels 20 to a roll of commercially acceptable size to be readily dispensed from a thermal printer. The length of the coated lamination 34g is directed from roll 50b over a pair of rollers 62 to a web guide splicing station 60. From the web splicing station it is guided over additional rollers 62 to a print station 70. Although only one print station 70 is shown, it should be understood that if the labels are printed with a plurality of different colors, a separate print station would be provided for each color. The lamination 34g is delivered from the web guide splicing station 60 to the print station over a plurality of rollers 62 and a drive roller 62a.

The printed lamination 34g is then delivered to a die cutting station 74 which cuts only through the layers of thermal coating 24, the face paper 30 and the adhesive 28. The liner strip 22 and silicone coating remain intact and uncut. The lamination 34g leaves the cutting station 74 and is directed to a scrap label matrix rewind station 76 where the matrix of scrap material is peeled from the liner strip 22 and wound to form a roll 78 of scrap material. Following removal of the scrap material there remains the liner strip 22 with the individual labels 20 affixed thereto as shown in FIG. 5. The label strip 22 with individual labels 20 carried thereon continues to be passed over and between rollers to a scissor cut station 80 which severs the strip 22 into lengths of suitable dimension for rolling into a desired commercial size roll. These lengths are transferred to a turret rewinding machine 82 having individual spindles 84 for rolling such lengths into commercial size rolls 86. The rolls 86 of labels 20/liners 22 are dispensed from the turret winding machine 82 to a transfer tote or other container 88.

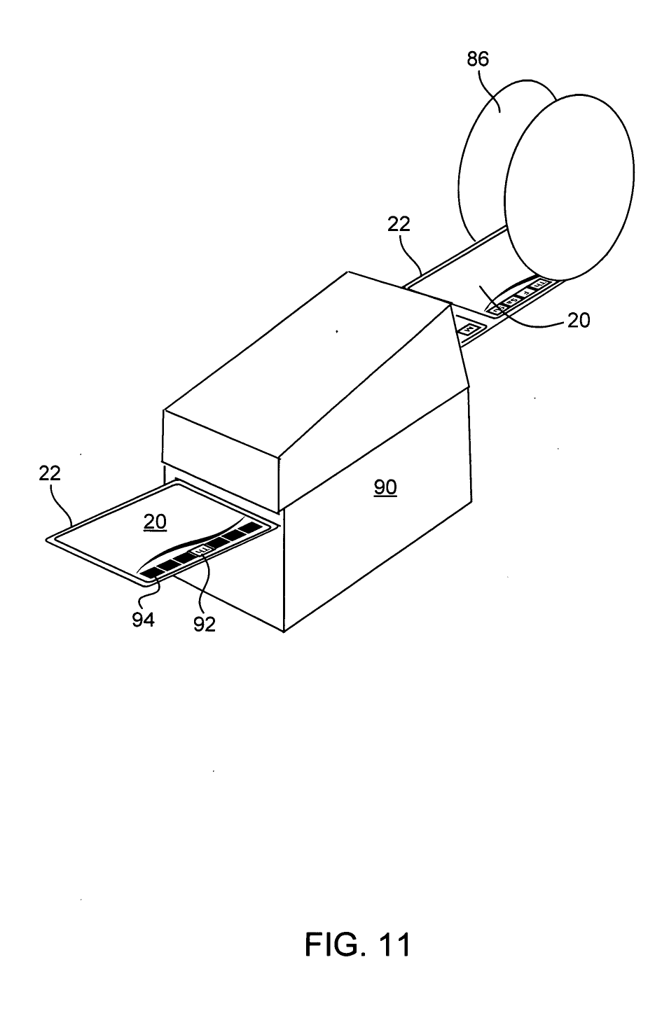

Referring to FIG. 11, there is shown a direct thermal printer 90 for receiving labels 20 and a liner strip 22 supporting and carrying such labels. Labels 20 and a strip 22 may be introduced into the direct thermal printer 90 from a commercial size roll 86 of liner strip 22 and labels 20. The direct thermal printer 90 is shown dispensing a label 20 carried on a length of liner 22, which label 20 has been printed by the direct thermal printer 90 to obliterate all areas of the printed day of week indicia except one, namely, the area indicated at indicia 92 having the indicia “Th” representing the day of the week (Thursday) by which the goods in the container to which the label is to be attached should be used. The remaining portions of the printed indicia are shown with obliterations 94 which block out the printing of the remaining days of the week.

One type of direct thermal printer which may need to be utilized is one sold by the assignee of the present invention, CMC DayMark Corporation, as its item no. 115224. Following removal of the label 20 and liner strip 22 from the direct thermal printer 90, the liner strip 22 may be peeled from the label 20 and the label affixed to a container of goods.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. A label comprising:
(a) a water dissolvable paper or water dispersible paper;
(b) a silicone coated liner affixed to one surface of said paper;
(c) water dissolving adhesive between said paper and said liner;
(d) a coating applied to the surface of said paper opposite said liner, said coating as applied to said paper being water dissolvable or water dispersible and having the capability of receiving thereon printing or other indicia from a direct thermal printer;
(e) indicia on said coating representing each of the seven days of the week; and
(f) printing from a direct thermal printer overlying and blocking out the indicia of one or more of said days of the week.
(g) said label being affixable on surfaces or containers following removal of said liner.

2. The label according to claim 1 wherein said printing blocks out of said indicia of all but one days of the week.

3. A label comprising:
(a) substrate of paper or other material;
(b) a dissolving adhesive applied to one surface of said substrate;
(c) a liner releasably attached to said substrate by said adhesive;
(d) a coating applied to the surface of said substrate opposite said adhesive, said coating as applied to said substrate having the capability of receiving thereon printing or other indicia from a direct thermal printer;
(e) indicia on said coating representing each of the seven days of the week;
(f) said label, being affixable to a surface or container following removal of said liner and having thereon printing from a direct thermal printer overlying and blocking out the indicia of one or more of said days of the week.

4. The label according to claim 3 wherein said printing blocks out of said indicia of all but one days of the week.

5. A label for goods intended to be used or disposed of by a specified time comprising:
(a) a strip of label material;
(b) a plurality of indicia printed on said strip, each said indicia representing one of the seven days of the week; and
(c) obliterations blocking the visibility of some but not all of said indicia.

6. A label for goods intended to be used or disposed of by a specified time comprising:
(a) a strip of label material;
(b) a coating on said strip, said coating having properties suitable for receiving printing or other images from a thermal printer;
(c) a plurality of indicia on said strip, each said indicia representing one of the seven days of a week; and
(d) printing or other images induced by a thermal printer blocking the visibility of some but not all of said indicia.

7. A method for forming a label capable of having formed thereon printing or other indicia by direct thermal printing comprising the steps of
(a) printing indicia representing each of the seven days of the week; and
(b) affixing to a portion of said seven days of the week indicia printing from a direct thermal printer overlying and blocking out the indicia of one or more of said days of the week.

8. A method of labeling goods or containers of perishable goods to provide indicia indicating the day of the week by which said goods should be used or disposed of comprising the steps of:
(a) providing a strip of label material having printed thereon indicia for each of the seven days of the week;
(b) loading said strip of label material into a printer;
(c) causing said printer to obliterate the indicia on said strip of label material for some but not all days of the week; and
(d) affixing said strip of label material with said obliterated indicia to said goods or said container.

9. A method of labeling goods or containers of perishable goods to provide indicia indicating the day of the week when said goods should be used or disposed of comprising the steps of:
(a) providing a strip of label material;
(b) applying to said strip a coating having properties suitable for receiving printing or other indicia from a thermal printer;
(c) printing on said strip indicia for each of the seven days of the week;
(d) loading said strip of label material into a thermal printer;
(e) causing said printer to obliterate the indicia on said strip of label material for some but not all days of the week; and
(f) affixing said strip of label material with said obliterated indicia to said goods or said container.

10. A label formed according to the method of claim 9.

11. A label according to claim 10 attached to said goods or said container.
